(19) United States
(12) Patent Application Publication
(10) Pub. No.: US 2014/0258174 A1
(43) Pub. Date: Sep. 11, 2014

(54) Method and System for Stock Valuation and Positional Risk Analysis of Company Stock

(71) Applicant: Brooks Hall, Audubon, PA (US)

(72) Inventor: Brooks Hall, Audubon, PA (US)

(21) Appl. No.: 13/785,774

(22) Filed: Mar. 5, 2013

(51) Int. Cl. G06Q 40/06

(52) U.S. Cl. CPC G06Q 40/06
USPC 705/36 R

(57) ABSTRACT

A system for assessing company valuation and positional risk of a stock price includes a storage device for receiving a current company earnings value for a stock, a current stock price, a desired rate of return, and a selected growth analysis time period, and an application processor executing instructions to determine an equity discount rate based on the greater of either a benchmark interest rate plus an equity premium or a floor equity discount rate where the application processor executing instructions to determine an implied earnings value based on a current stock price and the equity discount rate. The system further includes a graphic display device for displaying a visually intuitive graphical user interface for assessing company valuation and positional risk of a stock price including an interactive priceline assessment tool, and an interactive required earnings projection tool, each having graphically adjustable values.

### FIELD OF THE DISCLOSURE

The present disclosure generally relates to the field of securities and market analytic tools and securities trading tools, and more particularly relates to evaluating positional risk of an investment security price in view of implied earnings, desired return expectations, and/or market return rates, and to determining an investment decision based on the evaluation.

### BACKGROUND

There is no widely accepted method for valuing company stocks. Some investors ignore stock values on the assumption that it is too complicated and time consuming, and based on the assumption that markets are efficient. They adopt various strategies such as indexing and diversification as the basis for selecting their investments and managing risk. Proponents of fundamental analysis believe that investors may reasonably calculate an intrinsic value for a stock. An intrinsic value is, according to the fundamental analysts, a theoretically correct value for the company. They attempt to calculate this value by studying the company's operations in order to develop an estimate of future earnings and then discounting them into a present value for the company. This approach has a long history as described in Graham and Dodd's classic text Security Analysis (1934) and John Burr Williams' text The Theory of Investment Value 1938). Critics of this approach point out that projecting future earnings is a complicated, time consuming process that requires significant subjective judgment and produces a range of potential values that are not worth the effort. The Gordon Model is a variation of the basic discounted future earnings model that uses dividends as its measure of earnings. There are other variations on the discounted earnings approach (e.g. CAPM, discussed below.) As an alternative, investors adopt rules of thumb or imprecise metrics.

Various approaches and metrics provide some information about securities prices and risk, but have various shortcomings. For example, the price-to-earnings (P/E) ratio is the most common measure of valuation. Unfortunately, this single number combines two conceptually different ideas, a discount rate and an earnings growth rate. Thus it does not explicitly provide investors with information about either the discount rate or the earnings growth rate. PEG ratios attempt to address earnings growth, but like P/E ratios result in a number that does not identify the discount rates used or account for changing discount rate environments.

For investors, a company's value is closely associated with the concept of risk. Risk is traditionally measured based on the volatility of a company's price. The Capital Asset Pricing Model (CAPM) is based on the assumptions that investors demand higher rates of return for stocks with higher risk and that volatility is a sufficient measure of risk. It measures risk by comparing the volatility of a stock with the broad market. This measure, beta, is frequently published as a measure of risk. Unfortunately, CAPM has a poor empirical record.¹ Value at risk (VaR) is another measure of risk based on the historic volatility of a stock or portfolio. It calculates a probability distribution of historical price movements. This is used to provide a measure of the risk that the stock or portfolio will fall below a threshold level of risk within a given time period. VaR is criticized for providing a poor measure of risk.² 1 Fama and French (2004), The Capital Asset Pricing Model: Theory and Evidence, Journal of Economic Perspectives, Vol 18, Number 3, pp 25-46.2 Taleb, N (2007), The Black Swan: The Impact of the Highly Improbable, Random House

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of a network including servers, personal computers, and mobile devices that may be used to perform the methods and implement the system for assessing company valuation and positional risk of a stock price described herein;

FIG. 2 is a flow chart illustrating one embodiment of generating analytic tools used with the system for assessing company valuation and positional risk of a stock price as described herein;

FIG. 3 is one example of a graphical user interface illustrating system controls and data inputs for an embodiment of a system for assessing company valuation and positional risk of a stock price as described herein;

FIGS. 4A and 4B are flow charts illustrating one embodiment of generating a required earnings growth projection tool used with the system for assessing company valuation and positional risk of a stock price as described herein;

FIGS. 5A, 5B, and 5C are three examples illustrating a graphical user interface with a required earnings growth projection tool in accordance with one embodiment of the system for assessing company valuation and positional risk of a stock price for a company as described herein;

FIG. 6 is an another example illustrating a graphical user interface with a required earnings growth projection tool in accordance with one embodiment of the system for assessing company valuation and positional risk of a market index level as described herein;

FIGS. 7A and 7B are flow charts illustrating one embodiment of generating a priceline assessment tool used with the system for assessing company valuation and positional risk of a stock price as described herein;

FIG. 8 is an example illustrating a graphical user interface with a priceline assessment tool in accordance with one embodiment of the system for assessing company valuation and positional risk of a stock price as described herein;

FIG. 9 is another example illustrating a graphical user interface with a priceline assessment tool in accordance with one embodiment of the system for assessing company valuation and positional risk of a market index level as described herein;

FIG. 10 is a flow chart illustrating one embodiment of generating a historic implied earnings tool used with the system for assessing company valuation and positional risk of a stock price as described herein;

FIG. 11 is an example illustrating a graphical user interface with a historic implied earnings tool in accordance with one embodiment of the system for assessing company valuation and positional risk of a stock price as described herein;

FIG. 12 is another example illustrating a graphical user interface with a historic implied earnings tool in accordance with one embodiment of the system for assessing company valuation and positional risk of a market index level as described herein;

FIG. 13 is another example illustrating a graphical user interface with one embodiment of the system for assessing company valuation and positional risk of a stock price including each of the interactive analytic tools used for positional risk assessment in the system as described herein; and

FIG. 14 is a block diagram illustrating an embodiment of servers, personal computers, mobile devices, or other computing system architecture that may be used to perform the methods and implement the creation and use of embodiments of the system for assessing company valuation and positional risk of a stock price as described herein.

### DETAILED DESCRIPTION OF THE DRAWINGS

Currently there are no tools that assist an investor in understanding and provide a visually intuitive representation of the relationship between the stock's current stock price, an equity discount rate based on the relationship between the broad market earnings and the broad market prices, the earning implied in the stock price by that discount rate and the relationship between the earnings implied in the price and company's current earnings. Additionally, there are no tools that assist an investor in understanding and provide a visually intuitive representation of the relationship between their desired rate of return, a projected market rate of return, and the earnings growth necessary to support the investor's desired rate of return, based on a company's stock price, the earnings implied in the price, and the company's current earnings. In addition, there are no tools that provide an investor with a method of examining positional valuation from three different time perspectives: historical, current, and projected. Moreover, there is no tool utilizing the one or more above factors in determining a buy or sell investment decision or triggering an investment decision order. Due to a large number of variables in evaluating a security price, a computerized method and system are required whereby the calculations may be conducted on a large amount of data, including historical data and future projection data, to evaluate the above relationship and to determine investment decisions.

A system for assessing company valuation and positional risk of a stock price or other investment is described that comprises a system of servers and databases connected to a network that can host the analytic tools of the interactive system for assessing company valuation and positional risk of a stock price. The network also contains servers from which the analytic tools can be accessed by a user such as an investor seeking to make an informed investment decision about company valuation and the positional risk of a stock or other investment. The embodiments discussed herein most often discuss individual stocks, but it is understood that the analytic tools may be used to assess positional risk of other investment securities as well. The analytic tools of the embodiments described herein may relate to assessment of other securities investments, such as broader market index investment (e.g., an S&P 500 ® index), exchange traded funds (ETFs), mutual funds, individual stocks or other investment securities. Each of these investments have metrics relating to or analogous to those used in the analytic tools and discussed below. Certain examples below will make this application clearer.

The analytic assessment tools of the system for assessing company valuation and positional risk of a stock price each provide a visually intuitive assessment of stock price, current company earnings, and implied earnings in the stock price. Together, the analytic positional risk assessment tools provide a powerful system for evaluating stock price, or the price position of another type of investment security in view of current market conditions.

The analytic positional risk assessment tools of the system for assessing company valuation and the positional risk of a stock price utilizes an equity discount rate based on historical analysis of the relationship between the broad market earnings and the broad market prices compared to a benchmark interest rate reported at the time of the assessment. The benchmark interest rate may be the a rate of return on a United States Treasury security such as the 10 year note or may be based on other standard interest rates such as Triple A Corporate Bonds Yields. The analytic assessment tools of the system for assessing company valuation and the positional risk of a stock price utilizes estimated market returns. These returns may relate to any broader stock market and may be based on the long term historical performance of one or more broader market indexes such as the S&P 500 ®, the Dow Jones Industrials Average®, the NASDAQ composite Index®, or similar indexes. Estimated market returns may also be based on overall historical market performance. The analytic assessment tools of the system for assessing company valuation and the positional risk of a stock price utilizes company earnings. Usually the analytic assessment tools use fully-diluted twelve month trailing reported earnings; however, due to differences in accounting and capital structures other measures of earnings may also be used. The term “company earnings” refers to all measures of company earnings.

The traditional fundamental approach company valuation attempts to estimate a theoretically correct price for a stock. It does this by studying a company's operations and financial reports and general economic conditions in order to develop an estimate of future company earnings. The stream of future estimated earnings is then discounted to a present value. Critics point out that this is complicated, time-consuming process that relies on subjective judgments and produces a range of uncertain results. Traditional measures of risk are based on historic price volatility. The Capital Asset Pricing Model (CAPM) measures risk using beta, which is the volatility of a security relative to the broad market. Value at Risk (VaR) use price volatility to measure the historic distribution of price volatility and then use it a predictor for the frequency of future losses. Both measures are criticized. One criticism is that historic volatility is not a good predictor of future volatility. For example, periods of excessive valuation, called “bubbles”, often develop during a period of low volatility. A second criticism is that volatility measures under-estimate the magnitude of potential risk.

A positional analysis of stock price relative to its earnings avoids these problems. Positional analysis clearly identifies the existence and magnitude of valuation risk. Positional analysis has the additional advantage of allowing investors to customize the analysis to their investment situation. In addition, positional analysis uses easy to understand, visually intuitive tools that yield measures and visually intuitive views of risk such as implied earnings, implied earnings growth, required earnings growth to meet investment expectations, risk reward ratios, and percentage differences between company earnings and implied earnings. Positional analysis produces information that provides investors with the basis for an investment decision. In yet another embodiment, the investment decision recommendation may even trigger a buy or sell order based on threshold ratios or measurements being met as a result of the positional risk analysis using the system.

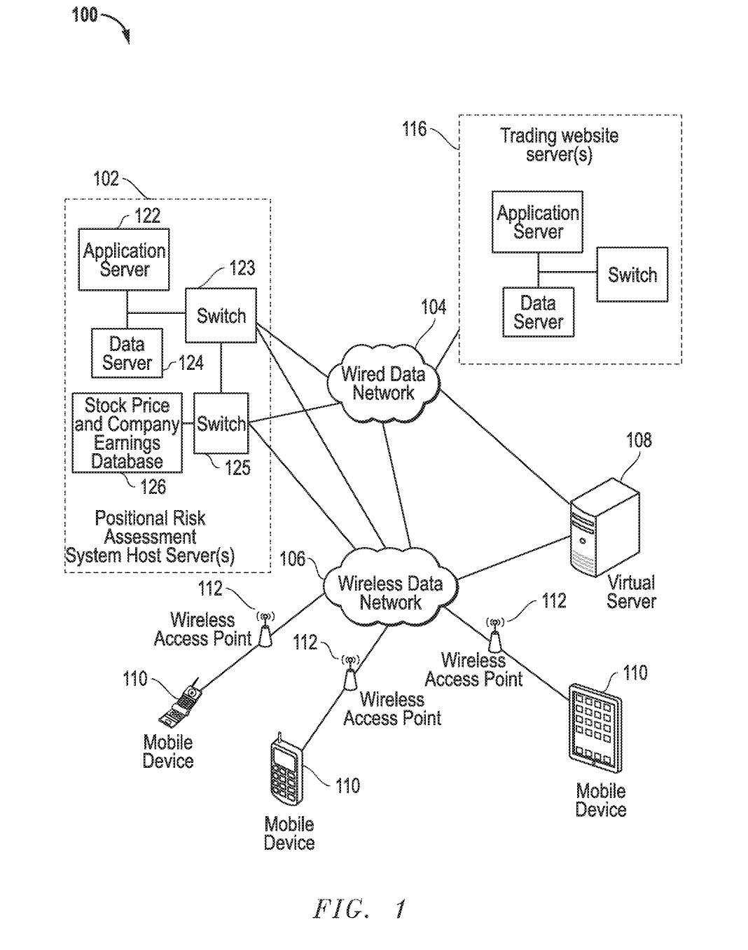

The system for assessing company valuation and positional risk of a stock price or other investment interfaces with a network 100, such as the Internet, that may include wired and wireless portions. The system for assessing company valuation and positional risk of a stock price or other investment may reside on one computing system in the network, or may implement several computing system components within the network. For example, receiving, storage, processing, and display for each of the analytic position risk assessment tools may be conducted on a single machine. Alternatively, display and interactive feedback may be sent to and received from a computing device such as a mobile computing device connected to the server hosting the system for assessing company valuation and positional risk of a stock price or other investment via a network as shown in FIG. 1. FIG. 1 shows a block diagram for a network 100 for use in connection with one embodiment of the system for assessing company valuation and positional risk of a stock price or other investment according to one embodiment. The system for assessing company valuation and company valuation and positional risk of a stock price or other investment host server 102 may include one or more servers for hosting portions of positional risk assessment system. For example, host server 102 for the system for assessing company valuation and positional risk of a stock price or other investment may include one or more application servers 122 and data servers 124 to operate the set-up, interface, control and data processing layers of the positional risk assessment system. Server 102 may include database 126 in an associated memory device to host external market data acquired such as historical and current stock prices, stock earnings, broader market performance, and benchmark interest rate data. Database 126 may also acquire and store received user input preference data to be used with the analytic tools described herein. Network 100 may include a wired data network 104 or a wireless data network 106. In an embodiment with a set of multiple servers as part of the positional risk assessment system, the host server 102, the multiple servers, such as 122, 124 and database 126 may be coupled to the wired data network 104 or wireless data network 106 via a switch or switches 123 and 125 or some other interface.

The system for assessing company valuation and positional risk of a stock price or other investment described in various embodiments herein is implemented in a set of instructions running on the computer hardware, including processors and memory, that comprise any of the servers or the databases depicted at 102, or in an alternative embodiment the set of instructions may run on a completely self contained device such as mobile devices 110. In the networked embodiment, the host server 102 for the positional risk assessment system may be coupled to a wired 104 or wireless data network 106 that can be a global network, a wide area network, a local area network, WiFi networks, WiMAX networks, Bluetooth networks, WiLAN networks, CDMA, TDMA, or other types of cellular networks, or other version of network. In an example, this can include all or some portion of the Internet. The network system 100 may include one or more mobile devices 110 via wireless access points 112. The overall network system 100 can include a virtual server 108 that can couple the wired data network with the wireless network and serve a system or data base function from a remote location other than the positional risk assessment system host server 102.

In an embodiment, a trading website server 116 is connected to wired data network 104 or wireless network 106. The trading website server 116 may host a securities trading system. The trading website server 116 may receive transmission of account identifying information, security key information, and a buy or sell order or investment recommendation that triggers procedures for a buy or sell order. The buy or sell order or investment recommendation may be received from the system for assessing company valuation and positional risk of a stock price or other investment to one or more investment accounts managed by the trading website server 116. The buy or sell recommendation or order may include a confirmation requirement before execution.

A mobile device 110 or similar standalone computing systems such as a laptop computer (not shown) may be coupled to wired data network 104 or the wireless data network 106 as well. The mobile devices 110 may be used to connect to the system for assessing company valuation and positional risk of a stock price or other investment to view and interact with the system and analytic positional risk assessment tools. Mobile device 110 has known interactive capabilities as a touchscreen, touchpad, mouse, trac-ball, or other device permitting interaction with locations on a display of the analytic tools of the positional risk assessment system. Moreover, in other embodiments as discussed, the mobile devices 110 or similar standalone computing devices may host all portions of the positional risk assessment system.

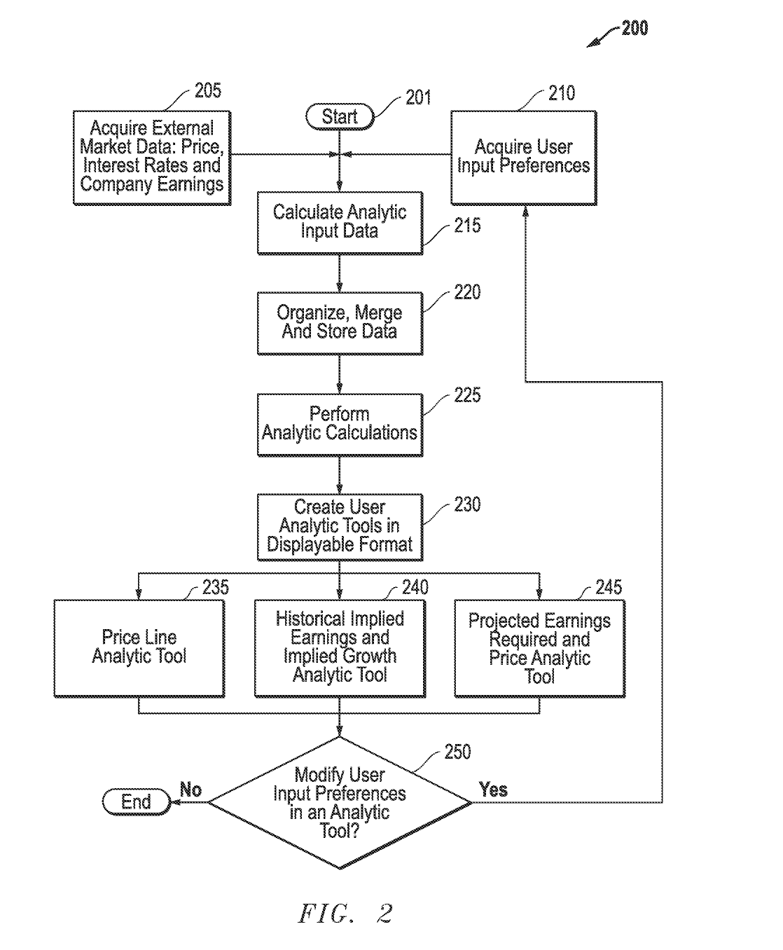

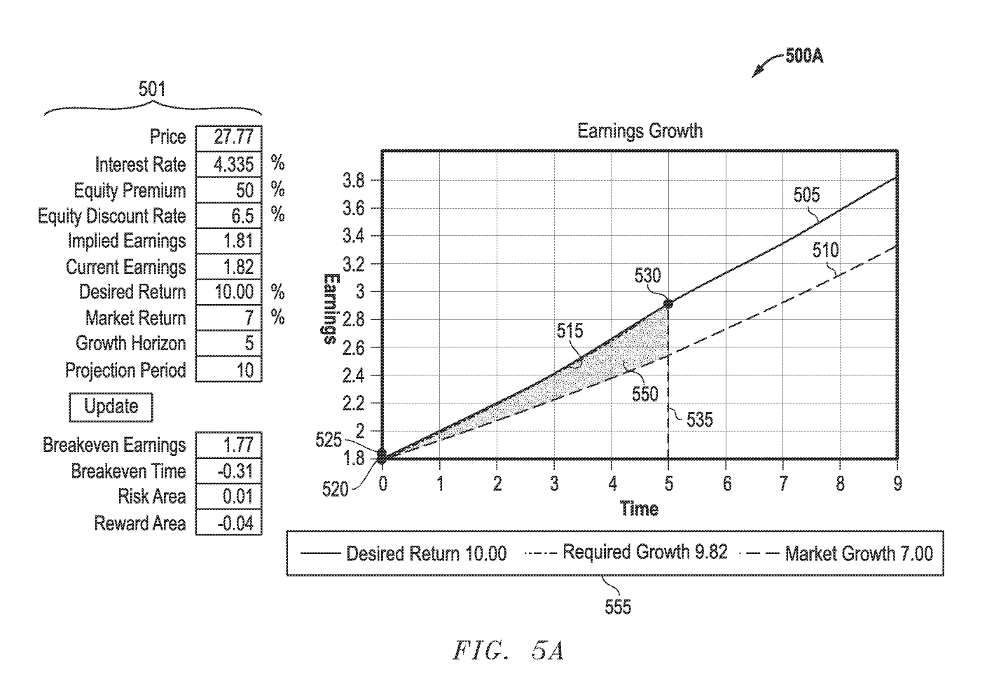

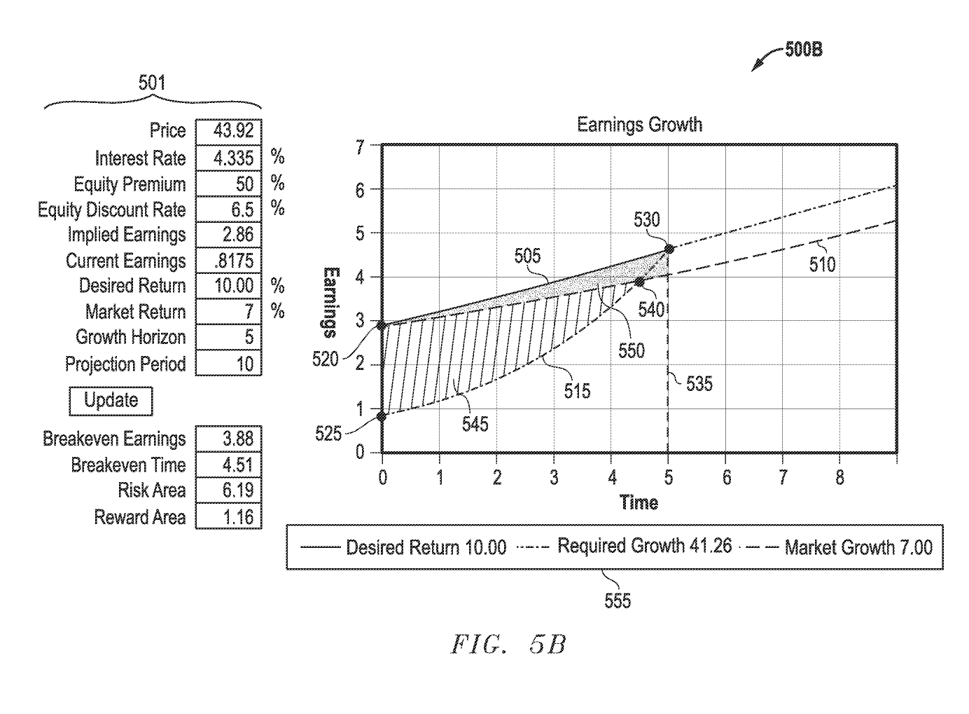

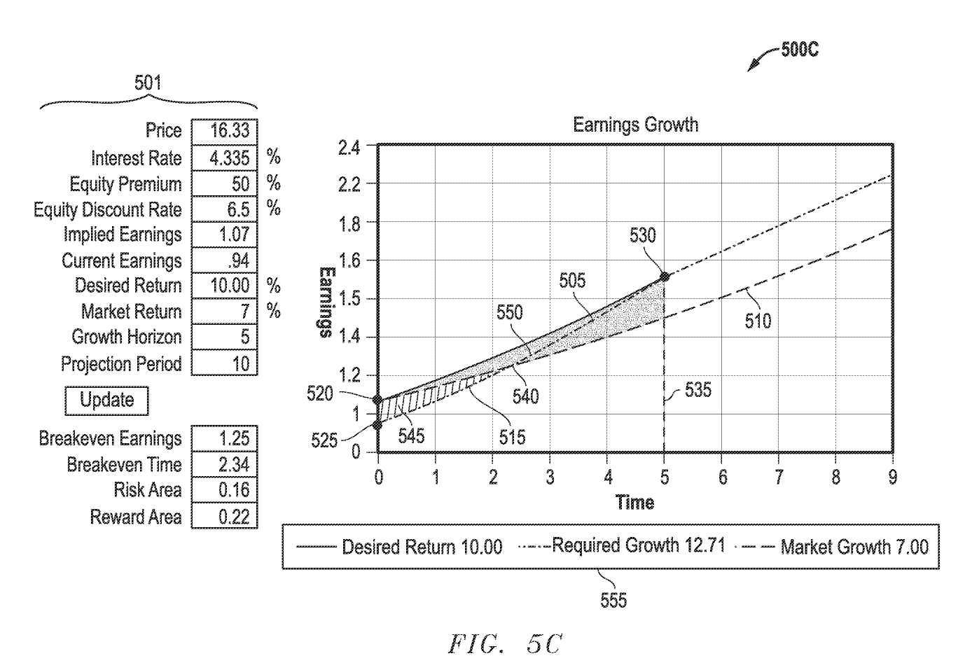

FIG. 2 shows a flow chart embodiment of a method for generating analytic tools used with the system for assessing company valuation and positional risk of a stock price as described herein. The method and analytic tools, separately and as a whole, provide an intuitive evaluation of a company's stock price by measuring earnings implied in the current stock price and comparing the earnings implied in the price to company earnings and other measures of earnings and earnings growth. The earnings implied is not based on prior volatility nor estimated future earnings. It is based on current price and an equity discount rate based on the relationship between the broad market earnings and the broad market prices. As will be seen below, “current” is the time point of analysis and may be a point in the past. For example, in FIG. 5B below the “current” time point is a view from December 1999 just before a “tech bubble” correction. The method also shows company growth required to meet the investor's desired rate of return.

The system for assessing company valuation and positional risk of a stock price or other investment, such as a market index, operates as follows according to the method of FIG. 2. The flow begins at 201. At 205, the positional risk assessment system collects external market data for storage in a memory device database of the host computing system. Information is collected including the current price of the stock or an investment security. Historical price information is also collected for storage if not already in the database. The system also acquires the current benchmark interest rate data at 205 and historical data relating to the benchmark interest rate used, if not already stored in the database. Historical market index performance data is received into the database if not already stored there as well. Current and historical records of company earnings are collected or updated at the database in memory. For a market index evaluation, the average company earnings over all stocks in the index is collected or calculated at the database.

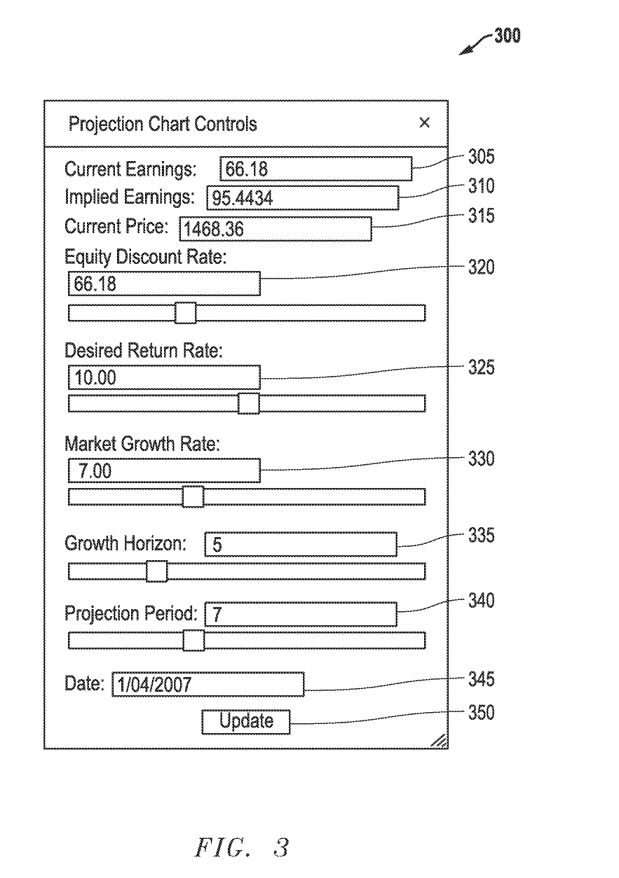

Proceeding to 210, the system acquires user input preferences from a graphical user interface such as the example described further with respect to FIG. 3 or from the analytic tool interface. The company valuation and positional risk assessment system is designed to provide maximum flexibility to intuitively view the positional risk of the stock by permitting user input on several assumptions within the implied earnings framework. This allows the user to customize the analysis to their personal situation or, in the case of an investment advisor, the individual situation of their clients. In the present embodiment, the user preferences for the equity discount rate, the user's desired rate of return, and growth period for analysis are examples received from the user input graphical user interface.

Proceeding to 215, the system processor calculates analytic data from the user preferences and acquired data. The calculations include determining the equity premium and equity discount rate from the acquired data and preparing statistical measurements of historic market earnings growth. At 220, the system organizes merges and stores in a memory the calculated analytic data with the user input preferences and the acquired market or stock data. Data is prepared and organized for additional analytic calculations and collection of results relating to developing each of the analytic tools. For example, one set of data is organized and prepared for calculations to result in the priceline analytic tool, another set of data is prepared for the historic implied earnings and implied growth analytic tool, and another set of data may be prepared for the projected required earnings growth and price tool. To the extent certain calculations or acquired values are relevant to more than one analytic tool, the processor may merge the calculations and data among sets of stored data to keep the basis of analysis consistent among the analytic tools.

Proceeding to 225, the system processor prepares another set of calculations. In particular, the system processor determines the earnings implied in the price of the stock or other investment security. In an embodiment of the system disclosed herein, the calculation of earnings implied in a present stock price involves multiplying the stock price times an equity discount rate that reflects the current state of the broader market. The broader market may be the same market or market index which the stock is a part of, or may be a reflection of market conditions as expressed by current benchmark interest rates. An assumption is that, current benchmark interest rates imply market conditions when they are within certain levels. While not necessarily specific to the stock being evaluated, the equity discount rate calculation based on the broader market conditions of the current system provides a lower reasonable boundary of potentially appropriate discount rates for the individual stock. This in turn provides a theoretical upper boundary for the reasonable price of the stock or other investment security. This imparts a degree of certainty in the equity discount rate.

When benchmark rates are very low or very high, they may not accurately reflect broader market conditions. Benchmark interest rates are related to the performance of stocks or a market by an equity premium value. In the case of rates that are very low, as with recent interest rates, a floor level of the equity discount rate or the interest rate used to calculate the equity discount rate may be required to establish a reasonable equity discount rate minimum. This floor level interest rate may be determined based on relationship of the equity discount rate to the historical performance of a wider market index. For example, the estimated, conservative S&P 500 ® performance has historically been between 6% and 7% return. Benchmark interest rates below, for example 4%, begin to get away from the ongoing performance of the S&P 500 ® market index. Thus, setting a floor interest rate at a value somewhere in the range of 3.5% to 4.5%, for example, is not an unreasonable assumption for the equity discount rate calculation using an equity premium value. Consequently, this sets a floor at the lowest reasonable equity discount rate and yields an assessment of the highest reasonable value for the stock or investment security even at low benchmark interest rates. With this information about a current stock price, or even historical stock prices, other metrics may be compared to evaluate the reasonableness of the stock price.

At 230, the system processor creates the user analytic tools in a displayable format on an interactive graphical user interface. This includes displaying on a graphical display device associated with the host device for the positional risk assessment system. Alternatively, the analytic tools may display on another computing device connected to the company valuation and positional risk assessment system device via a network system as described in FIG. 1. In the example embodiment, the analytic tools include a priceline analytic tool 235, a historical implied earnings and implied growth analytic tool 240, and a projected required earnings and price growth analytic tool 245.

The system proceeds to decision diamond 250 where the user may manipulate initial input such as an equity discount rate, desired rate of return, or growth analysis period to view how the results would change based on altered input. Then the system proceeds back to 210 to re-determine analytic calculations and create the analytic tools accordingly. The alteration of initial input may also be received at the company valuation and positional risk assessment system by manipulation of the graphically displayed results in the analytic tools to alter the user input preferences or the market data values from the database. Such alteration of values or graphic manipulation of features of an analytic tool provides real-time feedback on the effect in the altered analytic tool. It allows the investor to alter the evaluation to include information specific to the investment security or to the investor. In another embodiment, the manipulation of one analytic tool affects one or more of the other analytic tools in real time providing efficient response showing an intuitive view of the company valuation and positional risk of a stock price. If no alteration to the input values is received, the process ends until adjustment data is received.

In an embodiment depicted in FIG. 3, the graphical user interface 300 is shown in illustrating system controls and data inputs for an embodiment of an investment positional risk assessment system. In this particular embodiment, graphical user interface 300 is used to collect user input preferences and may be populated with external information acquired and stored in a database memory of the positional risk assessment system host device such as that depicted in 126. Graphical user interface 300 shows controls for a projected required earnings and price analytic tool. In an alternative embodiment, several controls shown in 300 are used in other analytic tools in the positional risk assessment system and adjustments to these values automatically alters the other analytic tools as well.

The graphical user interface shown in 300 is a screenshot of the controls in this example. At 305, the current company or investment security earnings may be populated from data. At 310, the implied earnings are shown. At 315, the current price of the stock or investment security is displayed from the database. In the present example, the level of the S&P 500 ® is shown. An equity discount rate is shown at 320 with a slide bar indicating that this value is adjustable. Adjustment of any value provides for redetermination of the projected required earnings growth analytic tool by the company valuation and positional risk assessment system. At 325, the desired rate of return may be set and adjusted using a slide bar in the present embodiment. Shown in the example is 10%, a value above estimated S&P 500 ® rates of return based on historical performance. While any value may be selected, it is understood that the more realistic the desired return expectations are, the more useful the positional risk assessment system will be. At 330, the market return rate may be set and adjusted to reflect a comparison of the desired return rate to a baseline growth rate such as the estimated market return rate. This estimated market return rate may be based on a historical performance of a wide market index or may be based on the estimate return of an alternate investment. The alternate investment return rate may be something other than stock, such as a return on real estate investments or an investment in business operations.

A setting for the growth horizon is shown in 335 with an adjustable slide bar. The growth horizon is the duration of time where the earnings growth of a company must meet the desired rate of return on the current implied earnings level. The projection period 340 shows the length of future time to be depicted in the projected required earnings growth analytic tool beyond the growth horizon. A date code is shown at 345 and an update control is depicted at 350 for sending a command to the positional risk assessment system processors to re-determine the calculations and amend the analytic tool or tools accordingly.

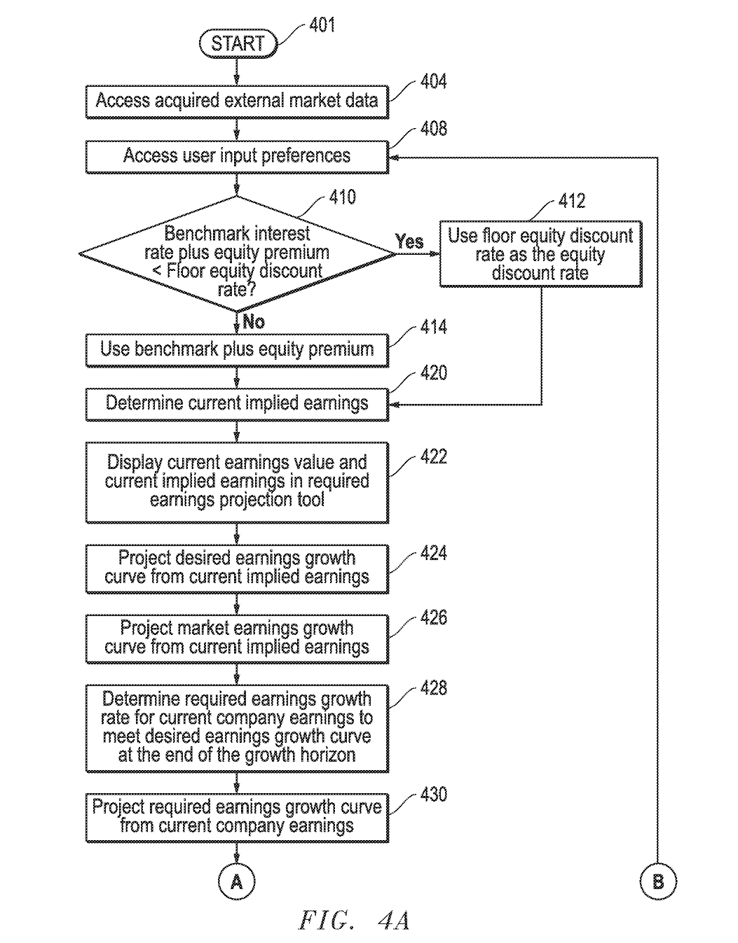

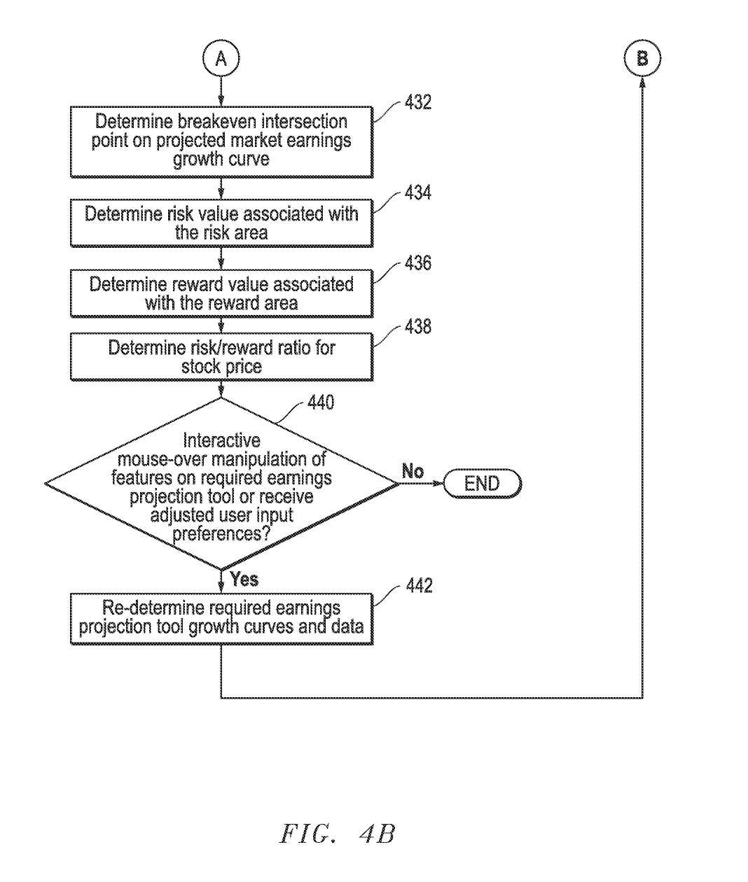

FIGS. 4A and 4B show flow charts illustrating the exemplary method 400 of generating a projected required earnings growth analytical tool. In FIG. 4A, the method starts at 401 and proceeds to 404 where the positional risk assessment system processor accesses databases containing acquired external market data from a memory device. The external market data may include current stock price or other investment security price, a benchmark interest rate, a floor equity discount rate, an equity premium value, and a current reported company earnings value. The equity premium value is the premium attached to a stock investment or other investment security to distinguish it from a safe investment that yields, for example, the benchmark interest rate. The equity premium is adjustable to account for higher yield that investors demand over the safer benchmark yield. An example benchmark interest rate includes a 10 year U.S. Treasury security, the corporate AAA yield and similar low-yield, low-risk securities. In the current embodiment, the equity premium is set at 50% to reflect a 50% premium attached to a stock investment above a benchmark rate yielding security. The investor may select a different equity premium. Additional external market data may include historic rate of return performance of a selected market index or an estimated future market index rate of return derived from historic information. This latter value may be adjustable depending the reference point market or investment selected or depending on conservative or aggressive assumptions about the same.

At 408, the system accesses user input preferences. These user input preferences are generally adjustable values that may include a investor's desired rate of return, the equity discount rate, the projection period of time to be shown in this analytic tool, and the growth horizon period of time for analysis of how long earnings will take to grow to meet a desired earnings growth rate.

Proceeding to decision diamond 410, the system processor determines whether a benchmark interest rate plus the equity premium is lower than a floor equity discount rate. If so, the floor equity discount rate is determined as the equity discount rate at 412. If not, the benchmark interest rate is used at 414. The benchmark interest rate is multiplied by the equity premium and added to itself to yield an equity discount rate at 412. At 420, the positional risk assessment system processor determines the implied earnings value from the current stock price and the equity discount rate value. In the current embodiment, the current stock price is multiplied by the equity discount rate to yield implied earnings in the stock. Other embodiments are contemplated where the current stock price is replaced by a recent average stock price or the equity discount rate is modified.

Proceeding to 422, the positional risk assessment system displays the current company earnings and the implied earnings value on a y-axis of a display screen. At 424, using the desired rate of return as an earnings growth rate, the company valuation and positional risk assessment system processor projects a desired earnings growth curve from the current implied earnings value along a time-series x-axis over the projection period. The rate of return in a specific embodiment may be based on an annual percentage rate, but the calculation may be performed on shorter (for example, quarterly or monthly) time periods.

The y-axis is displayed as a measure of earnings, but in an alternative embodiment the y-axis may be expressed instead as price by applying the equity discount rate to the earnings values. In yet another embodiment, a second y-axis expressed as price may be displayed along with the first y-axis expressed as earnings.

At 426, the system processor projects the estimated market return rate as a market earnings growth curve from the current implied earnings value on the y-axis. The market growth rate, as explained can be an estimated rate of return of any market index based on historical performance data, estimated return of another type of investment to be compared, and may be adjustable to reflect an aggressive or conservative view for the basis of comparison. The market growth rate may be an annual percentage rate or other growth rate measure. The market earnings growth curve is projected as a time-series over the projection period.

The company valuation and positional risk assessment system processor then determines at 428 a required earnings growth rate for current company earnings, also depicted on the y-axis to grow to meet the desired earnings growth curve at the end of a growth horizon period. This slope of required earnings growth over the growth horizon period represents a measurement of positional risk in the current stock price. The slope of the required earnings growth represents the company earnings growth necessary to support the investor's desired rate of return; it is not an estimate of actual earnings growth. The higher the investors desired rate of return, the higher the required growth necessary to meet that return. The greater the difference between implied earnings and current company earnings, the greater the required earnings growth rate. Since implied earnings increases with price, the slope of required earnings growth over the growth horizon period represents a measurement of positional risk in the current stock price. At 430, the system processor projects a required earnings growth curve from current company earnings to intersect the desired earnings growth curve at the end of the projected growth horizon period. The required earnings growth curve explicitly informs the investors about the relationship between their desired return and the earnings growth necessary to support that return providing the basis for an investment decision.

The projected required earnings growth curve intersects the market earnings growth curve at a point along the curve typically before reaching the desired earnings growth curve. In FIG. 4B, the company valuation and positional risk assessment system processor determines this intersection point, and the earnings level and time point for the point at 432. This represents the breakeven point of an investment in the stock or investment security at the present price. It is the point at which the actual earnings must grow to equal an investment in a wider market index or another reference investment reflected by the market earnings growth curve. The time point at this intersection point gives positional risk assessment information indicating the reasonableness that the earnings will grow to a breakeven point in the determined amount of time on the way to the desired earnings growth curve. Additional growth in actual earnings that occurs after this point represents an expected reward derived from the stock investment.

At 434, the positional risk assessment system processor determines the area of the projection curves bounded by the y-axis or current time and the projected required earnings growth curve and the projected market earnings growth curve. In other words, the area between the required earnings growth curve and the market earnings growth curve from the current time of analysis to the breakeven point. This area is a representation of a risk value for the stock or investment security relative to a purchase of a reference investment such as a market index fund. The positional risk assessment system processor then determines a reward value at 436. The reward value is determined from the area bounded by the market earnings growth curve, the desired earnings growth curve, and between the current time of analysis or the y-axis and the point at the end of the growth horizon time period. For the growth horizon time period of analysis, the reward area visually depicts the reward that may be expected based on the desired return rate.

Proceeding to 438, the positional risk assessment system processor determines a risk to reward ratio value that provides a measure or positional risk in the stock price or the price of the investment security. The system may also shade or highlight the risk area and reward area to provide further visually intuitive feedback to the user showing the relationship between the risk value and the reward value. The risk reward ratio and the breakeven time provides the investor with information concerning the risks and rewards associated with desired return, the alternative investment return and the earnings growth necessary to support that return providing the basis for an investment decision.

At decision diamond 440, the required earnings growth projection tool features may be manipulated or new data entered into the control fields of the graphical user interface to adjust the company valuation and positional risk analysis. For example, the growth horizon may be altered to provide analysis over a different time period. The equity discount rate may be adjusted to impact the current implied earnings starting point for the stock price. In another example, the estimated market return rate may be altered to provide a different market growth rate projection curve for reference. If a manipulation of the analytic tool features or an adjustment to the user selected input preferences occurs, the system proceeds to 442 where the positional risk assessment system processor re-determines the displayed required earnings growth tool projections in real time by looping back to block 408 in FIG. 4A. If no value adjustments or manipulation of features of the analytic tool are received, the process ends.

FIG. 5 depicts a specific example embodiment of the interactive required earnings growth projection tool 500. Three examples of the embodiment are shown at FIGS. 5A, 5B, and 5C. At 501, another example graphic user interface is shown similar to the one in FIG. 3. Additional displayed values include the equity premium, the break even earnings value, the break even time value, the risk area value and the reward area value. The stock used in this example is Microsoft Corp. (MSFT) and FIG. 5A shows a required earnings growth projection tool reflecting current MSFT values (2013). FIG. 5B shows the required growth projection tool reflecting MSFT shortly before the “tech bubble” in late 1999, and FIG. 5C shows the same for MSFT shortly after the “tech bubble” burst in late 2000. In each case, the specific stock example shows a current price for the relevant time and current earnings of MSFT at the time in 501. Generally, the features of the required earnings growth projection tool 500 are similar between specific examples in FIGS. 5A, 5B, and 5C. Differences will be noted.

The required earnings growth tool 500 depicts three projections, the desired earnings growth projection curve 505, the market earnings growth projection curve 510, and the required earnings growth projection curve 515. The desired earnings growth curve 505 and the market earnings growth curve 510 are both projected from the implied earnings value 520. The required earnings growth projection curve 515 is the growth in company earnings required for a company to meet the desired earnings growth with the equity discount rate applied to earnings. Starting from the current company earnings 525, the required earnings growth projection curves extend to an intersection point 530 at the end of the growth horizon time period 535. The breakeven point 540 is shown where the required earnings growth projection curve 515 intersects the market earnings growth projection curve 520. FIG. 5A does not show the breakeven point because current company earnings are greater than implied earnings, thus the required earnings growth is less than the investor's desired return and they do not cross in the growth horizon. The break even time point in the growth horizon is when an investment in the stock at the current value theoretically will equal the same investment in the reference market index (e.g., an index fund). This assumes the market rate of return applies to the reference market index investment 510. In FIG. 5B (1999), the breakeven point 540 shows that the earnings needed to grow to 3.88 from 0.8175 in 4.5 years to break even. In FIG. 5C (2000), the breakeven point 540 showed a different post-correction story. The earnings needed to grow to 1.25 from 0.94 in 2.35 years to break even; a much more reasonable growth trajectory. Currently, in FIG. 5A the required growth earnings tool shows that required earnings growth is less than the desired return. But this analytic tool provides only one view of positional risk of the stock price and other factors may need to be considered. The required growth rate, the breakeven time, and the risk reward ratio provides the investor with information concerning the relationship between their desired return, the alternative investment return and the earnings growth necessary to support that return providing the basis for an investment decision.

Except in FIG. 5A, the risk area is shown shaded at 545 and is the area between the required earnings growth projection curve 515 and the market earnings growth projection curve 510 in FIGS. 5B and 5C. It is also bounded by the current time at the y-axis in this example embodiment. While other embodiments may show time before the current time to include historical earnings growth trends, nonetheless the risk area is bounded by the current time. The historical earnings growth shows another positional risk view when juxtaposed to the required earnings growth projection curve 515.

The reward area is shown shaded at 550. It is the area between the desired earnings growth projection curve 515 and the market earnings growth projection curve 510. It is also bounded by the current time at the y-axis in this example embodiment and by the end time of the growth horizon time period 535.

Both the risk area region and the reward area region may be highlighted to emphasize their magnitude relative to one another. A measure of the both areas is shown in 501 and a ratio between the areas may be determined. In FIG. 5A (current), the positional risk is negative and small relative to the reward area value. In FIG. 5B (1999), the positional risk value is quite large relative to the reward value. In FIG. 5C (2000), the positional risk area value is much more reasonable relative to the reward area value.

Also shown in the interactive required earnings growth tool is the required earnings growth rate 555. In the specific embodiment, this is the annual percentage growth in earnings required for the company's current earnings 525 to meet the desired earnings growth curve 505 within the growth horizon time period 535. In the specific example of FIG. 5A (current), the company's earnings must grow annually at a rate of 9.82% to meet the investor's desired expectations of 10% rate of return. In FIG. 5B (1999) pre-correction, the company's earnings had to grow annually at a rate of 41.26% to meet the investor's desired expectations of 10% return rate. In FIG. 5C (2000) post-correction, the company's earnings had to grow annually at a rate of 12.71% to meet the investor's desired expectations of 10% return rate. The required earnings growth rate 555 reflects a positional risk of the stock price as expressed in the implied earnings value 520 and the desired rate of return from an investment in that stock at the current price relative to current company earnings 525. This is a valuable measure of positional risk of the stock for determining an investment decision about the stock. Buy and sell thresholds may be set for the required earnings growth rate whereby a level below a buy threshold required rate triggers a buy recommendation, and a level above a sell threshold triggers a sell recommendation. Additionally the market earnings growth curve 510 and breakeven point 540 provide further perspective on the position risk relative to a reference investment.

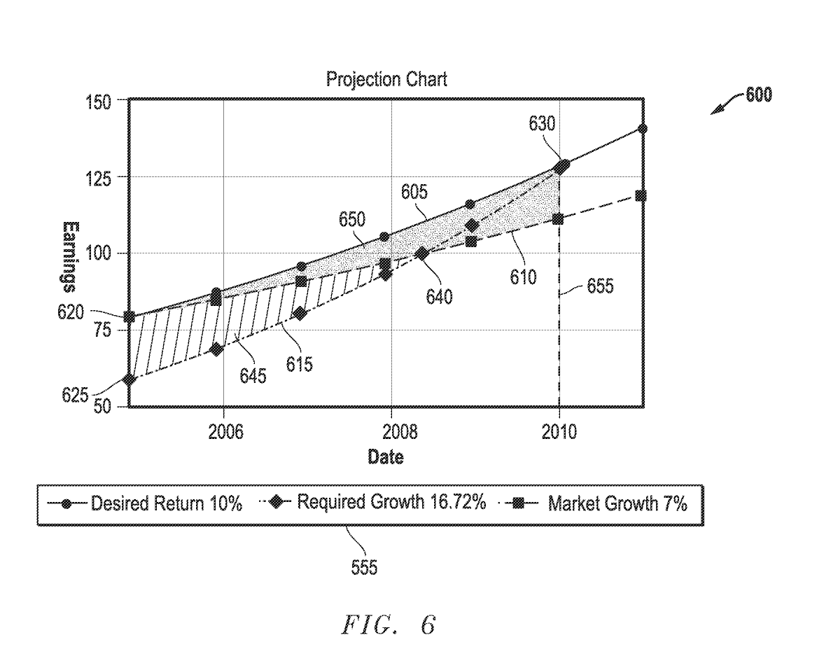

FIG. 6 depicts another specific example embodiment of the interactive required earnings growth projection tool 600. At 601, yet another example graphic user interface is shown similar to the one in FIG. 3. In this example embodiment, the analytic tool 600 is used to assess a market index value in 2005 to determine if the market is reasonably valued relative to its earnings. The market index, in this case the S&P 500, had a price of 1211.92 and current earnings of about 60. The current earnings represents the weighted value of the earnings of the components of the index.

The required earnings growth projection tool 600 depicts three projections, the desired earnings growth projection curve 605, the market earnings growth projection curve 610, and the required earnings growth projection curve 615. The desired earnings growth curve 605 and the market earnings growth curve 610 are both projected from the implied earnings value 620. The required earnings growth curve 615 is the growth in company earnings required for a company starting from the current company earnings 625 to meet desired growth expectations with the equity discount rate factored in. The required earnings growth curve 615 extends to an intersection point 630 at the end of the growth horizon time period 635.

The breakeven point 640 is shown where the required earnings growth projection curve 615 intersects the market earnings growth projection curve 610. This represents the time required for required earnings growth to equal the same investment in the reference market index based on an estimated rate of return based on historical performance. The breakeven point shows that the average earnings must grow to 100 from 60 in 3.4 years to break even.

The risk area is shown shaded at 645 and is the area between the required earnings growth projection curve 615 and the market earnings growth projection curve 610. It is also bounded by the current time for the analysis (2005 in this analysis) at the y-axis.

The reward area is shown shaded at 650 and it is the area between the desired earnings growth projection curve 615 and the market earnings growth projection curve 610. It is also bounded by the current time for the analysis and the end time of the growth horizon time period 635.

If the required earnings growth 655 is large to meet a desired rate of return or the breakeven point for market earnings growth, this may indicate that the market is over valued and there is a risk that the investor's desired rate of return will not be met. These measures reflect a positional risk of the market index as expressed in the implied earnings value 620 and are relative to the desired rate of return from an investment in the market. This is a valuable measure of positional risk of the market index for determining an investment decision about an investment security such as a market index fund.

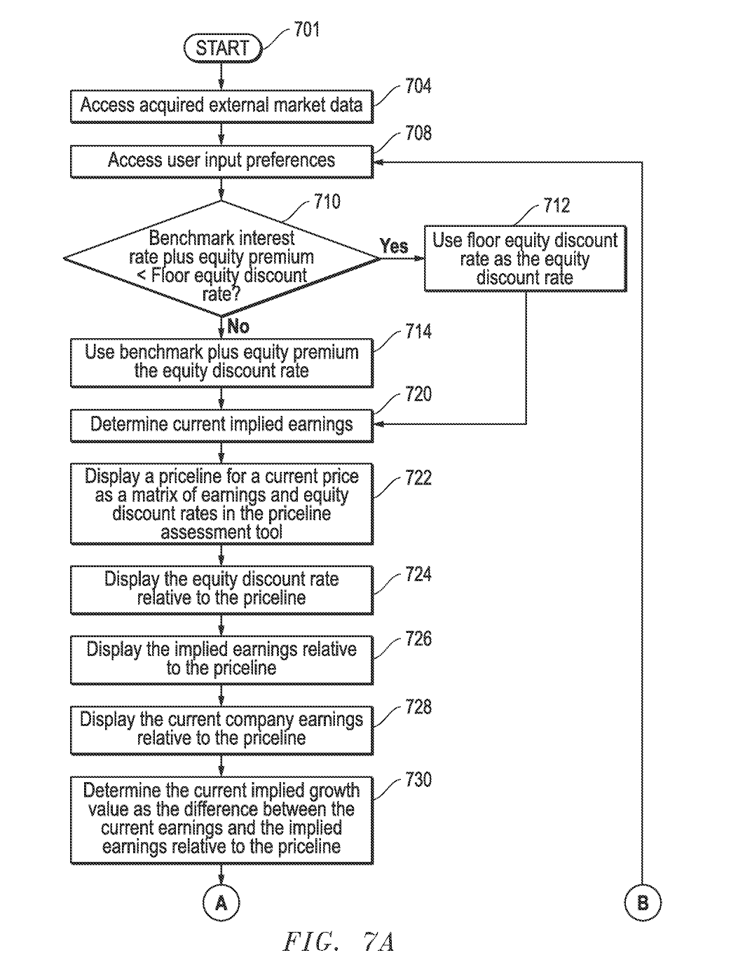

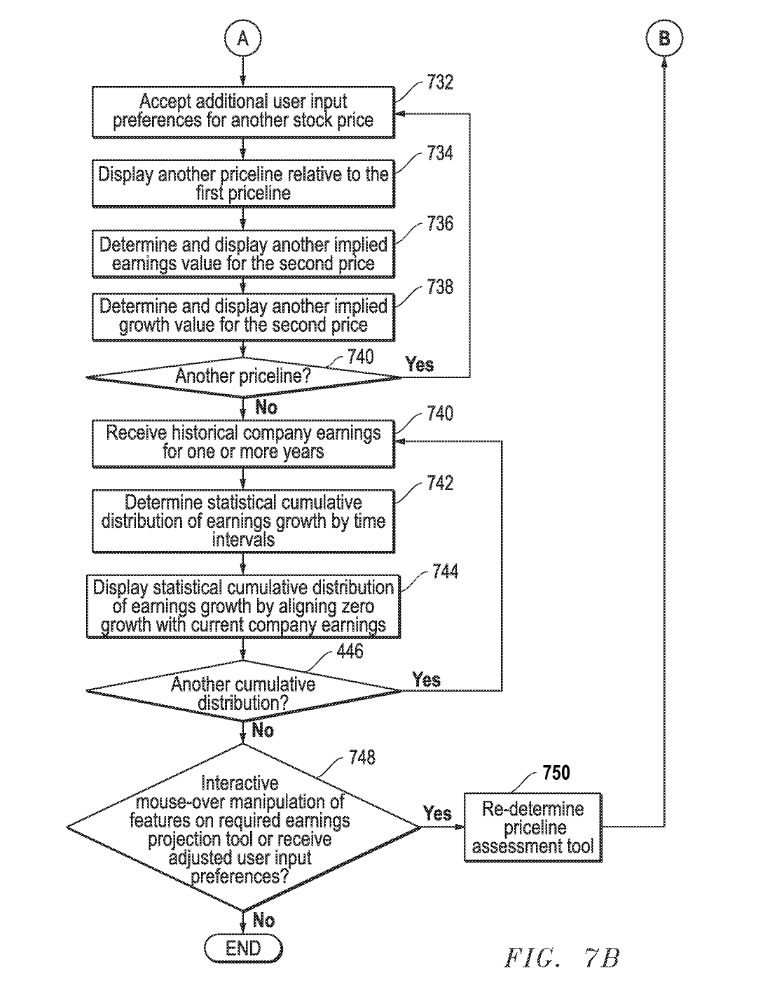

FIGS. 7A and 7B are flow charts depicting an exemplary method for generating a priceline assessment tool. The priceline assessment tool is used as part of the group of analytic tools in the system for assessing company valuation and positional risk of a stock price or other investment security. In FIG. 7A, the method starts at 701 and proceeds to 704 where the positional risk assessment system processor accesses databases containing acquired external market data from a memory device. The external market data may include current stock price or other investment security price, a benchmark interest rate, a floor equity discount rate, an equity premium value, and a current reported company earnings value. The equity premium value is adjustable to account for relative value of stock to benchmark interest yielding investments such as a 10 year U.S. Treasury Note or other benchmark security. In the current embodiment, the equity premium is set at 50% to reflect a 50% premium attached to a stock investment above a benchmark rate yielding security. The investor may select a different equity premium. Additional external market data may include historic earnings performance of the stock or other investment security.

At 708, the system processor accesses user input preferences. These user input preferences are generally adjustable values that may include adjustment values to the equity discount rate used, and input of stock price(s) to be used to determine additional reference pricelines in the priceline assessment tool. For example, a comparison may be desired between the current price and the historical price inflection points such as a 52-week low or a 52-week high. Alternatively, additional pricelines may reflect target earnings or price growth or contraction levels, for example at levels of 10% variations from the current stock price.

Proceeding to decision diamond 710, the system processor determines whether a benchmark interest rate plus the equity premium is lower than a floor equity discount rate. If so, the floor equity discount rate is determined as the equity discount rate at 712. If not, the benchmark interest rate is used at 714. The benchmark interest rate is multiplied by the equity premium and added to itself to yield an equity discount rate at 712. At 720, the positional risk assessment system processor determines the implied earnings value from the current stock price and the equity discount rate value. In the current embodiment, the current stock price is multiplied by the equity discount rate to yield implied earnings in the stock. Other embodiments are contemplated where the current stock price is replaced by a recent average stock price or the equity discount rate is modified.

Proceeding to 722, the company valuation and positional risk assessment system processor prepares and displays a priceline for the current stock price as a linear matrix of earnings values to equity discount rates based on the relationship between the equity discount rate, stock price and earnings. The priceline is displayed on a graph with earnings on one axis and discount rates on the other axis. The priceline is a diagonal line that represents each earnings, discount rate pair that produces the displayed price. At 724, the positional risk assessment system displays the equity discount rate applied to the stock price from the y-axis of the priceline tool on a graphical display device. The system processor then determines implied earnings value for the stock price from the equity discount rate at 726. The implied earnings value is displayed in the priceline assessment tool from the x-axis relative to the priceline. At 728, the system applies the current company earnings from the x-axis of a displayed priceline tool to show the relationship between the current company earnings level and the implied earnings level implied in the current stock price. The system processor then determines a current implied growth value as the difference between the implied earnings value and the current earnings value for the stock at 730. This difference may be displayed along the x-axis of the priceline assessment tool between the implied earnings value and the current earnings value for the stock. The priceline together with the investor's discount rate and the earnings implied by that rate provides the investor with information and a visual tool that provide the basis for an investment decision.

Continuing on to FIG. 7B at 732, the positional risk assessment system processor of the currently described embodiment accepts additional user input preferences or accesses those already received in storage that relate to display of additional pricelines in the priceline assessment tool. The system displays another priceline at 734 for the second stock price as a linear matrix of earnings value to equity discount rates based on the relationship between the second equity discount rate, second stock price, and earnings. A second implied earnings value is determined by the positional risk assessment system and displayed with the priceline assessment tool at 736. At 738, a second implied growth value for the added stock price is determined by the system processor from the difference between the second implied earnings value and the current company earnings. This second priceline, associated implied earnings, and associated implied growth value provides a valuable reference point tool for viewing the current stock price. The system processor proceeds to decision diamond 740 to determine if another priceline is to be added to the priceline assessment tool. If so, the process proceeds back to block 732. If not, the system proceeds to block 740 to determine and display statistical cumulative distribution of historical earnings growth in the priceline assessment tool. The priceline together with the investor's discount rate and the earnings implied by that rate and their relationship to reference price lines and the earnings implied by those lines provide the investor with information and a visually intuitive display of the information that provides the basis for an investment decision.

At 740, the positional risk assessment system receives historical data of company earnings for a period of time. Proceeding to 742, the system processor determines a statistical cumulative distribution of earnings growth over the historical time period. In the example embodiment, this may be a 1 year cumulative distribution or a 2 year cumulative distribution. Any historical time period is understood to be useful. The historical time period and earnings growth data is broken into equal time intervals. Each partitioned time interval represents a data point indicating growth in earnings in that interval. The system processor gathers and merges the time interval earnings growth data points and generates a statistical, cumulative distribution of growth rates based on frequency of growth rate percentages in the intervals. The cumulative distribution data is plotted in a curve relative to the pricelines at 744 whereby the zero growth data points align with the current company earnings. This cumulative distribution curve provides a reference to gauge the probability of earnings growth reaching sufficient levels to meet the implied earnings growth in a stock price. The relationship of the priceline and the earnings implied in the price at the investor's discount rate to cumulative distribution curve provides the investor with information that forms the basis for an investment decision.

The system proceeds to decision diamond 746 to determine if another cumulative distribution curve is to be generated and displayed in the priceline assessment too. If so, the process proceeds back to block 740. If not, the process proceeds to decision diamond 748.

At decision diamond 748, the priceline assessment tool features may be manipulated or new data entered into the control fields of the graphical user interface to adjust the positional risk analysis. For example, the equity discount rate may be adjusted to impact the current implied earnings for the stock price of the priceline. If a manipulation of the analytic tool features or an adjustment to the user selected input preferences occurs, the system proceeds to 750 where the positional risk assessment system processor re-determines the displayed priceline assessment tool in real time and the process goes to block 708 in FIG. 7A. If no value adjustments or manipulation of features of the analytic tool are received, the process ends.

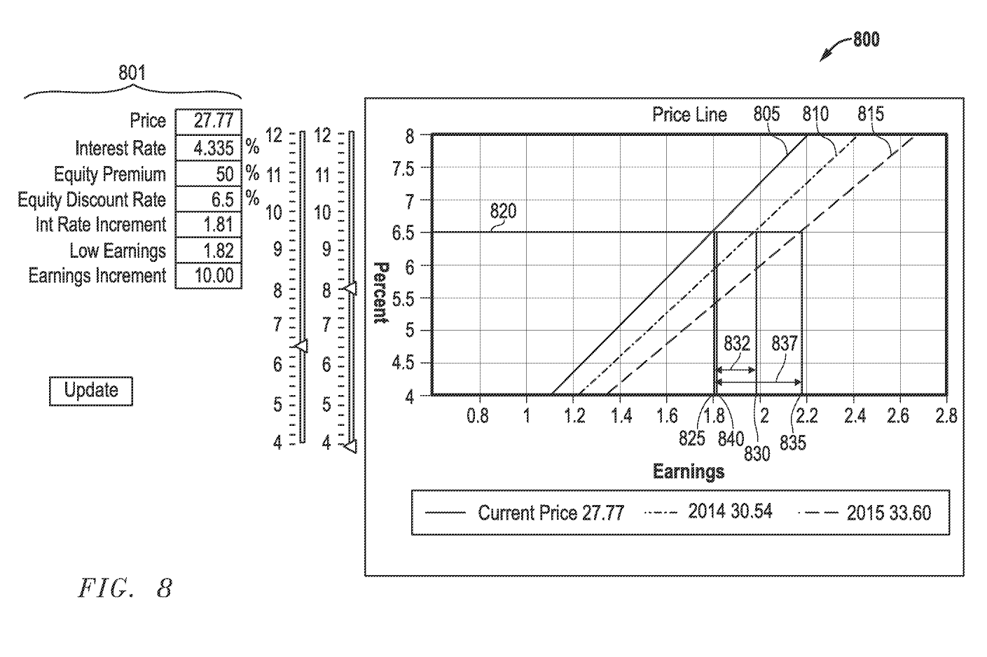

FIG. 8 shows an example embodiment of a priceline assessment tool 800. At 801, an example graphic user interface is shown similar to the one in FIG. 3 for the priceline assessment tool. Displayed values include the current price, benchmark interest rate, equity premium, equity discount rate, actual company earnings, and slide bars to adjust values in the priceline assessment tool. In this case, the specific stock example has a current price of $27.77 and current earnings of $1.82.

In this example embodiment the priceline assessment tool shows three pricelines. The first priceline 805 for the current price of $27.77 per share is depicted as matrix of earnings (per share) and equity discount pairs. The second priceline 810 is an anticipated growth in stock price of 10% in one year to $30.54. The third priceline 815 is yet another anticipated growth in stock price of 10% in the second year to $33.60.

The equity discount rate is displayed at 820 and set at 6.5% in this example embodiment. Current implied earnings are shown at 825 for the current stock price of $27.77. The second implied earnings value 830 is for the second stock price of $30.54, and the third implied earnings value 835 is shown for the third stock price of $33.60. Current company earnings are shown at 840. Current implied growth value is the difference between the current implied earnings 825 and the current company reported earnings 840.

Current implied growth value is not shown in FIG. 8 because, current company earnings are 1.82 and current implied earnings are 1.81 are too close. Moreover in this example, the current implied earnings growth is a negative value suggesting stock price is potentially undervalued. The stock in this case is Microsoft Corporation and other factors may be considered in addition to the factors shown by the priceline assessment tool. However, the Microsoft stock price is fairly reasonable compared to its current earnings.

With the priceline assessment tool, positional risk of the current stock price can be evaluated based on the magnitude of the current implied growth value. If the implied growth value is very large as a percentage of the current company earnings, investment in the stock at the current price is risky compared to its current earnings. Additionally, the priceline assessment tool provides an intuitive visualization of the implied growth as it relates to other reference stock pricelines 810 and 815 and the second and third implied earnings 830 and 835 associated with those prices. Any number of reference pricelines are contemplated. The relationship of the priceline and the earnings implied in the price at the investor's discount rate to implied earnings at additional reference pricelines provides the investor with information that forms the basis for an investment decision.

In another embodiment, a second implied growth value 832 is the difference between the second implied earnings 830 and company earnings 840 for the second stock price. A third implied growth value 837 may similarly be determined by the system processor between the third implied earnings 835 and the company earning 840.

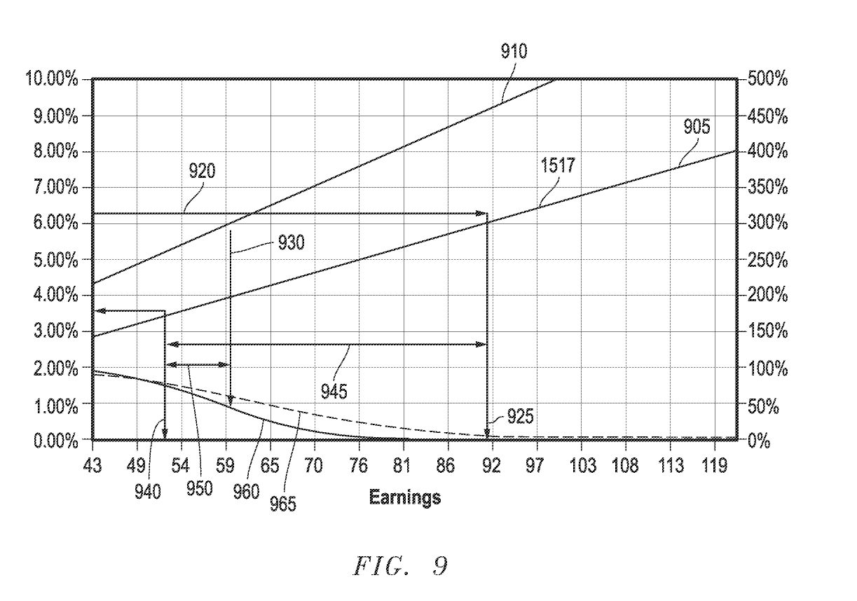

FIG. 9 shows another example embodiment of a priceline assessment tool 900. This case illustrates the S&P 500® in August 2000 when the “tech bubble” existed. In this case, the specific “current” market level at that time was 1517 with and current earnings at about 53.

In this example embodiment, the priceline assessment tool shows two pricelines. The first priceline 905 was for the current price level of 1517 for the S&P 500 ®. A second priceline 910 shows decreased market level by about 34% at a level of 1000.

The equity discount rate is displayed at 920 and set at 6% in this example embodiment; the identifying horizontal arrow is above the 6% grid line so that it is visible. Current implied earnings (in August 2000) were 91 shown at 925 for the level of 1517. The second implied earnings value 930 is for the second market index level of 1000 is shown to be approximately 60. The priceline assessment tool shows the first current implied growth value 945 as the difference between the current implied earnings 925 and the current company reported earnings 940 which were at 53 in August 2000 for the wider market index. As can be seen, the current implied growth 945 at the market index level of 1517 in August 2000 was large, almost 74% over current reported earnings. By comparison, the reference implied growth 950 associated with a market level of 1000 was only about 13% over current reported earnings.

The priceline assessment tools illustrates that prices positioned to the right of the graph imply greater earnings than prices positioned to the left of the graph. The priceline assessment tool provides a method and a tool that measures the positional risk, or earnings valuation risk, associated with the current price lines or a reference price line. With the priceline assessment tool, positional risk of the market levels in August 200 are readily apparent based on the magnitude of the implied growth value 945. The very large implied growth value 945 as a percentage of the current market earnings 940 indicated significant risk compared to then current earnings and, in this case a bubble in the market. The priceline assessment tool provides an intuitive visualization of the implied growth 945 as it related to another reference market level priceline 910 and its implied earnings 930. In this particular case, the there was indeed a tech bubble that corrected after August 2000.

A 1-year cumulative statistical distribution curve of earnings growth 960 is superimposed on the priceline assessment tool 900. Additionally, a 2-year cumulative statistical distribution curve of earnings growth 965 is also shown in the priceline assessment tool 900. Each cumulative statistical distribution curve 960 and 965 is aligned so that zero earnings growth statistics for time intervals in the historic earnings of the S&P 500 over the previous one or two years is aligned at the current earnings 940 at the time. As can be seen, this is another measure of the positional risk of the S&P 500 ® in August 2000. There was very little statistical history showing growth sufficient to reach the current implied earnings 925 to cover the implied growth gap 945 for either the one or two year distributions when the market was at a level of 1517. Thus, the current implied growth value 945 appears to be unreasonable at the S&P 500 level in August 2000.

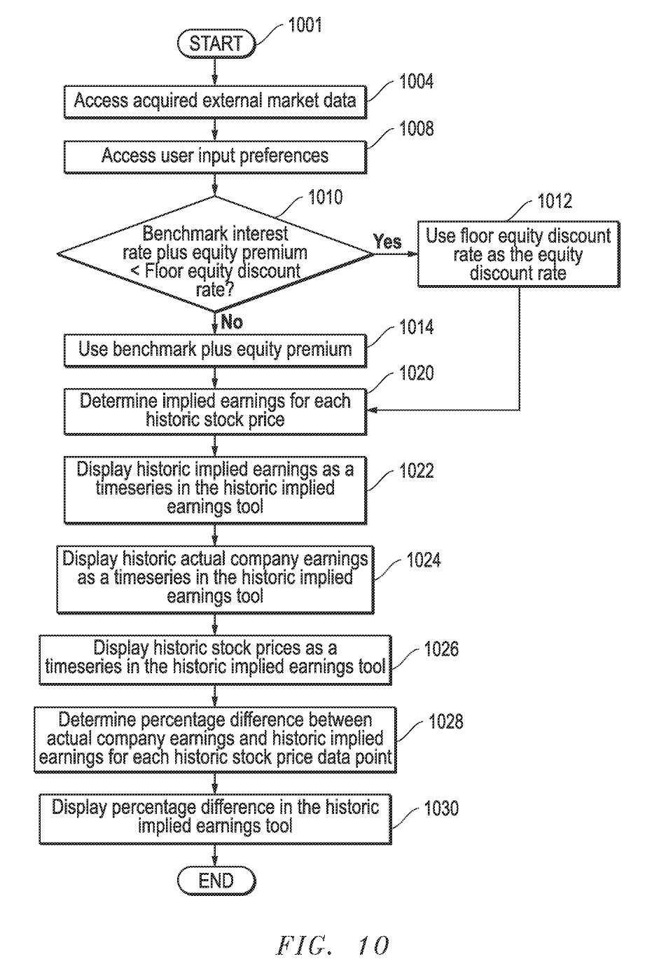

FIG. 10 is a flow chart depicting an exemplary method for generating a historic implied earnings analytic tool. The historic implied earnings tool is used as part of the group of analytic tools in the system for assessing company valuation and positional risk of a stock price or other investment security. The method starts at 1001 and proceeds to 1004 where the positional risk assessment system processor accesses databases containing acquired external market data from a memory device. The external market data may include current historic stock prices or other investment security prices, historic and current benchmark interest rates, a floor equity discount rate, an equity premium value, and current and historic reported company earnings values.

At 1008, the system processor accesses user input preferences. These user input preferences are generally adjustable values that may include adjustment values to the equity discount rate used. Proceeding to decision diamond 1010, the system processor determines whether a benchmark interest rate at each time point of the historical record plus the equity premium is lower than a floor equity discount rate. If so, the floor equity discount rate is determined as the equity discount rate for those data points at 1012. If not, the benchmark interest rate is used at 1014 to establish the equity discount rate for the time points as described above. At 1020, the company valuation and positional risk assessment system processor determines the implied earnings value from each current and historic stock price data point and the equity discount rate value relevant for that time point. In the current embodiment, the stock price is multiplied by the equity discount rate to yield implied earnings in the stock at each stock price data point over the history analyzed.

Proceeding to 1022, the company valuation and positional risk assessment system prepares and displays historic implied earnings as a time series in the historic implied earnings tool. At 1024, the historic actual company earnings are also displayed in the historic implied earnings tool 1000 on a display device as a reference to the implied earnings history. Historic stock prices are also displayed at 1026 along a time series to show stock price fluctuations relative to the implied earnings.

The system processor determines the percentage difference between the actual company earnings and the implied company earnings at each time point in the historic implied earnings tool at 1028 and this data is displayed in the analytic tool at 1030. The percentage difference between actual company earnings over history and historic implied earnings provides a powerful position risk analytic tool to view the performance of the company earnings relative to stock price and implied earnings in the past. The convergence and divergence of implied earnings with reported earnings and the percentage difference between the two (implied growth) provide the investor with information that provides the basis for an investment decision. This, along with the other analytic tools described above give a visually intuitive perspective on the potential future performance of a stock and its price position relative to current market conditions.

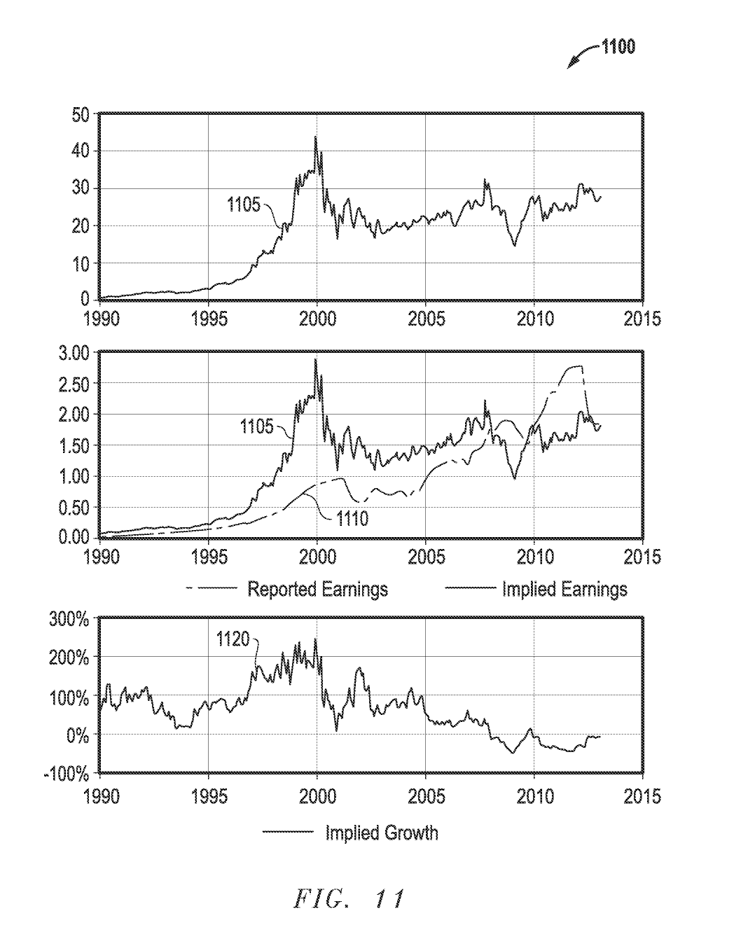

FIG. 11 shows an example embodiment of a historic implied earnings tool 1100. The historic implied earnings tool 1100 of present embodiment shows a time series of the implied earnings 1105 and the actual earnings 1110 for a stock, in this case MSFT stock as an example. Divergence of the two indicates risk in the stock price at those times, while convergence indicates less risk compared to the company's earnings at the time. At 1115, the stock price for the company is also tracked relative to the implied earnings 1105 and the actual company earnings 1110 in a related time series depiction. The percentage difference between the implied earnings and the actual company earnings at each time point for the stock is shown at 1120. This percentage difference is the implied growth of earnings in the current stock price. A greater percentage indicates a higher degree of positional risk for the stock price, whereas a lower percentage indicates a reduced risk relative to company earnings.

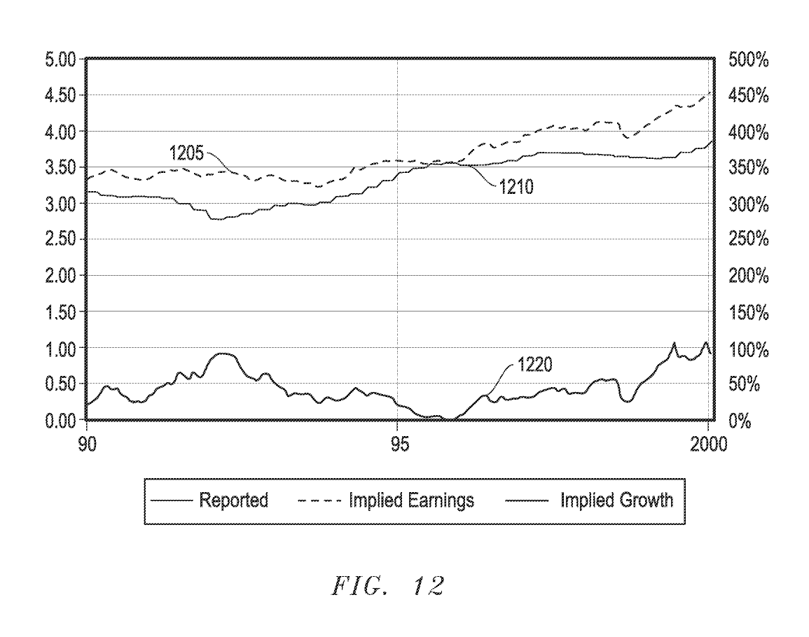

FIG. 12 shows another example embodiment of the historic implied earnings tool 1200. The historic implied earnings tool 1200 of this embodiment shows a time series of the implied earnings 1205 and the actual earnings 1210 for the S&P 500 ® market index up to the year 2000. Divergence of the two indicates risk in the market level at those times, while convergence indicates less risk compared to index earnings at the time. At 1220, the percentage difference between the implied earnings and the actual company earnings at each time point for the market level is shown. This percentage difference is the implied growth of earnings in the market level at that time. A greater percentage indicated a higher degree of positional risk for the market index, whereas a lower percentage indicated a reduced risk relative index earnings.

In the embodiment of FIG. 12, there are two y-axes, one for earnings and one for percentage relating to the implied growth value. Thus, the implied growth percentage 1220 may be depicted alongside the historic implied earnings 1205 and historic actual company earnings 1210 for comparison. As can be seen, a divergence and increased percentage occurred in the run up to the market correction for the “tech bubble” in 2000.

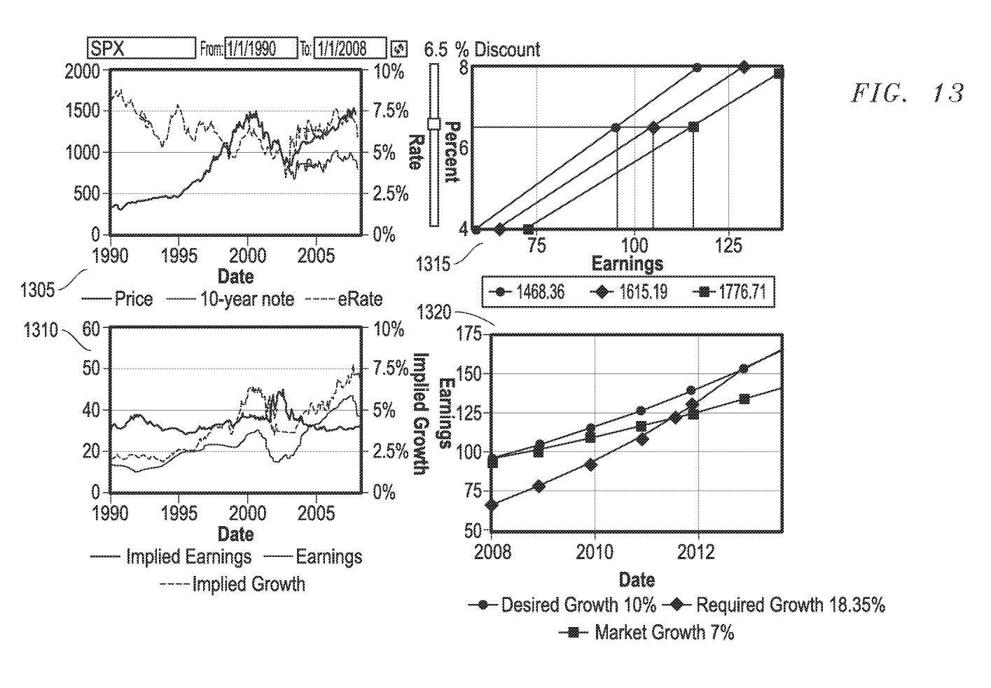

FIG. 13 shows another example embodiment of the system for assessing company valuation and positional risk of a stock price or other investment showing each of the analytical tools described herein. Shown is a tool depicting historic stock price and example benchmark interest rates over time at 1305. An example embodiment of the historic implied earnings tool is shown at 1310. The priceline assessment tool is shown at 1315. And the required earnings growth tool is shown for at 1320. In the specific embodiment of FIG. 13, the four analytic tools are shown relative to one another for data of the S&P 500 ® up to 2008 and for projections out through a growth horizon until 2013. Each of the analytic tools is interactive and values may be adjusted by click or touch on a feature to change it, by interface with a slide bar tool or by adjustment of values in the graphical user interface for user input preferences. The company valuation and positional risk assessment system alters the relevant values and features in the other analytic tools in real time by re-determining the value and the view of each tool. For example, an adjustment to the equity premium will affect equity discount rates. Such an adjustment will alter the historic implied earnings tool 1310, the priceline assessment tool 1315, and the required earnings growth tool 1320. This system provides the investor with three (3) time perspectives (historic, current and prospective) for understanding a company's valuation. This system provides information in a format that provides the basis for an investment decision.

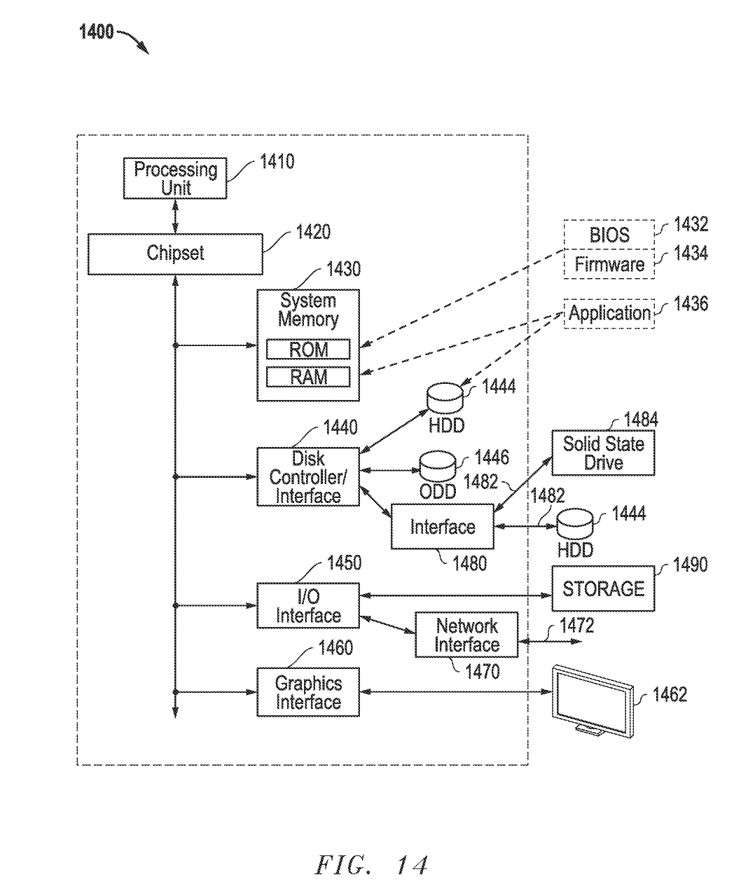

FIG. 14 is a block diagram illustrating an embodiment of a computer or server system 1400, including a processing unit 1410, a chipset 1420, a system memory 1430, a disk controller/interface 1440, an input/output (I/O) interface 1450, graphics interface 1460, and a network interface 1470. In a particular embodiment, the computer or server system 1400 is used to carry out one or more of the methods described herein for the system for assessing company valuation and positional risk of a stock price or other investment. As described above, a single computing system 1400 may host the positional risk assessment system to execute instructions to retrieve stored data and inputs for calculation of features of the analytic tools of the company valuation and positional risk assessment system via the processing unit 1410 and chipset 1420. The computing system 1400 may also display the analytic tools on a display 1462 via the graphics interface 1460. In another embodiment, one or more of the computer or server systems described herein are implemented with a storage database to host the video interactive selection system, to host the video provider website with client side code, and to carry out the methods described herein.

Chipset 1420 is connected to processing unit 1410 via a bus or other channel, allowing the processing unit to execute machine-executable code. In a particular embodiment, computer or server system 1400 may include one or more processing units. Chipset 1420 may support the multiple processing units and permit the exchange of data among the processing units and the other elements of the computer or server system. A bus or other channel permits the system to share data among the processing unit, the chipset, and other elements of computer or server system 1400.

System memory 1430 is connected to chipset 1420. System memory 1430 and chipset 1420 can be connected via a bus or other channel to share data among the chipset, the memory, and other elements of computer or server system 1400. In another embodiment, processing unit 1410 may be connected to system memory 1430. A non-limiting example of system memory 1430 includes static random access memory, dynamic random access memory, non-volatile random access memory, read only memory, flash memory, or any combination thereof.

Disk controller/interface 1440 is connected to chipset 1420. Disk controller/interface 1440 and chipset 1420 can be connected via a bus or other channel to share data among the chipset, the disk controller, and other elements of computer or server system 1400. Disk controller/interface 1440 is connected to one or more disk drives. Such disk drives may include an internal or external hard disk drive (HDD) 1444, and an optical disk drive (ODD) 1446, and can include one or more disk drives as needed or desired. ODD 1446 can include a Read/Write Compact Disk (R/W-CD), a Read/Write Digital Video Disk (R/W-DVD), a Read/Write mini Digital Video Disk (R/W mini-DVD), another type of optical disk drive, or any combination. Additionally, disk controller 1440 is connected to disk interface 1480. Disk interface 1480 permits a solid-state drive 1484 or external HDD 1444 to be coupled to a computer or server system 1400 via an external interface 1482. External interface 1482 can include industry standard busses such as a Universal Serial Bus (USB), IEEE-1394 Firewire, or other proprietary or industry-standard busses. Solid-state drive 1484 can alternatively be disposed within the computer or server system 1400. Any of the above drivers, individually or in combination, may save as the database storage for the merchant forum system. Alternatively, network links may connect to off-site memory or storage devices to save data as part of a merchant forum system database.

I/O interface 1450 may include an I/O controller and is connected to chipset 1420. I/O interface 1450 and chipset 1420 can be connected via a bus or other channel to share data among the chipset, the I/O interface, and other elements of computer or server system 1400. I/O interface 1450 is connected to one or more peripheral devices via possible intermediate channels and devices. Peripheral devices can include devices such as including a keyboard, mouse, or storage systems 1490, graphics interfaces, network interface cards 1470, sound/video processing units, or other peripheral devices. Network interface 1470 includes one or more network channels 1472 that provide an interface between the computer or server system 1400 and other devices that are external to computer or server system 1400. This includes an interface between the computer or server system 1400 that may host the merchant forum system and various wired and wireless networks connected to the mobile devices or computers of consumer members and merchants for executing the methods and system described herein.

Graphics interface 1460 is connected to chipset 1420 via a bus or other channel which permits exchange of data among the chipset, the graphics interface, and other elements of computer or server system 1400. Graphics interface 1460 is connected to a video display 1462.

Computer or server system 1400 includes Basic Input/Output System (BIOS) 1432 and firmware code 1432, and one or more application programs 1436. BIOS code 1432 functions initializes the computer server system 600 on power up to launch an operating system, and to manage input and output interactions between the operating system and the other elements of the computer or server system. In a particular embodiment, the BIOS 1432 and firmware code 1434 and application programs 1436 are stored in memory 1430. The BIOS code 1432, firmware 1434, and application programs 1436 include machine-executable code that is executed by processing unit 1410 to perform various functions of computer or server system 1400. In another embodiment, the BIOS code 1432, firmware 1434, and application programs 1436 are stored in another storage medium of computer or server system 1400. The BIOS code 1432, firmware 1434, and application programs 1436 can each be implemented as single programs, or as separate programs to implement the methods and merchant forum system described herein. The machine executable code used to execute the computer implemented method steps and create the merchant forum system described herein are examples of application programs 1436 in the described embodiments.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

1. A computer-implemented method for evaluation of a stock comprising:
receiving at a storage device a desired rate of return and a selected growth analysis time period;
at an application processor, executing instructions to determine an equity discount rate based on the greater of either a benchmark interest rate plus an equity premium or a floor equity discount rate;
determining a current implied earnings value of a stock based on a current stock price multiplied by the equity discount rate;
displaying a current company earnings value and the current implied earnings value for the stock as a function of earnings per time with earnings on a first axis and time on a second axis;
projecting a desired earnings growth curve from the current implied earnings value based on the desired rate of return over the selected growth analysis time period;
projecting a market earnings growth curve from the current implied earnings value based on the estimated market growth rate over the selected growth analysis time period;
executing instructions determining a required earnings growth rate necessary for projected future earnings to meet the desired rate of return at the end of the selected growth analysis time period;
projecting a required earnings growth curve from the current company earnings value to an intersection point on the projected desired earnings growth curve at the end of the selected growth analysis time period based on the required earnings growth rate,
wherein the displayed projections provide a visually intuitive tool for positional risk analysis of a stock's price relative to required earnings growth rate, the desired rate of return, and the projected market earnings growth rate.

2. The method of claim 1, further comprising:
determining a risk value representing a risk area size between the projected required earnings growth curve and the projected market earnings growth curve during the selected growth analysis time period, wherein the risk value represents a measure of risk in the stock;
determining a reward value representing a reward area size between the market earnings growth curve and the desired earnings growth curve during the selected growth analysis time period, and
determining a ratio of the risk value to the reward value.

3. The method of claim 2, further comprising:
preparing an investment decision when the required earnings growth rate is above or below a threshold value.

4. The method of claim 1, wherein the equity discount rate is a user selectable rate of return value.

5. The method of claim 1, further comprising:
displaying the current company earnings value, the current implied earnings value, and displayed projections on a graphical user interface,
wherein the equity discount rate, the selected growth analysis time period, the desired rate of return, or the expected market-based growth rate are adjustable to change the displayed projections and the view of the positional risk analysis of the stock's price in real time.

6. The method of claim 1, wherein the estimated market growth rate default value is based on a long term average historical earnings growth rate for a broad stock market index.

7. A computer-implemented method for evaluation of a stock price comprising:
receiving at a storage device a selectable equity discount rate;
at an application processor, executing instructions to display a first priceline as a linear matrix of pairs of earnings and equity discount rates for a current stock price;
displaying the selectable equity discount rate relative to the first priceline;
executing instructions determining an implied earnings value for the selectable equity discount rate, wherein the implied earnings value is the current stock price multiplied by the selectable equity discount rate,
displaying the implied earnings for the selectable equity discount rate relative to the first priceline;
wherein the displayed priceline provides a visually intuitive tool for positional risk analysis of a stock's price relative to implied earnings value.

8. The method of claim 7, further comprising:
receiving at the storage device a current company earnings value; and
displaying the current company earnings relative to the first priceline.

9. The method of claim 8, further comprising:
determining a current implied growth value in the stock based on the difference between the current company earnings value and the implied earnings value; and
displaying the current implied growth value in the stock price, wherein the implied growth value in the stock price shows a magnitude of earnings growth already incorporated into the current stock price.

10. The method of claim 9, further comprising:
displaying the first priceline and the current implied growth value on a graphical user interface,
wherein the selectable equity discount rate is adjustable to change the view of the positional risk analysis of the stock's price in real time.

11. The method of claim 7, further comprising:
displaying a second priceline as a second linear matrix of pairs of equity discount rates and earnings for a second stock price based on a selected stock price growth or loss level as an analytic reference for evaluating the current stock price.

12. The method of claim 7, further comprising:
displaying a second priceline as a second linear matrix of pairs of equity discount rates and earnings for a second stock price based on user criteria to provide an analytic reference for evaluating the current stock price including,
a historical stock price inflection point or a selected earnings level relative to the market-based discount rate.

13. The method of claim 9, further comprising:
receiving historical actual earnings for a stock at a storage device;
partitioning the historical actual earnings for the stock into periods of time;
determining a percentage of earnings growth over each of the periods of time of the historical actual earnings;
determining and displaying a statistical earnings growth cumulative distribution curve of the periods of time; and
aligning the point in the statistical earnings growth cumulative distribution curve representing zero growth with the displayed current company earnings relative to the first priceline,
wherein the display of the statistical earnings growth cumulative distribution curve provides a reference for comparison of implied earnings value to historical earnings growth.

14. The method of claim 13, further comprising:
setting a second priceline at another price of the stock higher or lower than the current price of the stock, so that the implied growth is at a threshold acceptable implied growth level,
wherein the second priceline determines an investment decision for the stock.

15. A computer-implemented method for evaluation of a stock price comprising:
receiving at a storage device historical stock prices, historical company earnings, and historical benchmark interest rates,
at an application processor executing instructions to determine an equity discount rate based on the greater of either a benchmark interest rate plus equity premium or a floor equity discount rate for each point in time in the historical benchmark interest rates;
at an application process, executing instruction determining a historical implied earnings value for each point in time in the historical stock prices based on the historical stock price multiplied by the equity discount rate for that point in time;
displaying the historical stock prices as a time-series;
displaying the historical company earnings value and the historical implied earnings value for the stock as a time series aligned with the historical stock price time series;
wherein the convergence and divergence of historic implied earnings with historical company earnings quantifies and provides a visually intuitive tool for evaluation of historical stock prices relative to their underlying earnings.

16. The method of claim 15, further comprising:
at an application processor, executing instructions determining a percentage difference at each point in time between the historical implied earnings value for each historical stock price and the reported company earnings for the same point in time;
displaying the percentage difference between the historical implied earnings value for each historical stock price and the historical company earnings for the same point in time aligned with the historical stock price time series.

17. An interactive system for assessing company valuation and positional risk of a stock price comprising:
a storage device for receiving a current company earnings value for a stock, a current stock price, a desired rate of return, and a selected growth analysis time period;
an application processor executing instructions to determine an equity discount rate based on the greater of either a benchmark interest rate plus an equity premium or a floor equity discount rate;
the application processor executing instructions to determine an implied earnings value based on a current stock price and the equity discount rate;
a graphic display device for displaying a visually intuitive graphical user interface for assessing company valuation and positional risk of a stock price comprising an interactive priceline assessment tool, and an interactive required earnings projection tool, each having graphically adjustable values; and
the application processor re-determining the values in the interactive priceline assessment tool and the interactive required earnings projection tool based on a graphical adjustment of a value and showing an effect of the graphical adjustment on the positional risk in real time;
wherein the interactive priceline assessment tool further comprises a first adjustable priceline based on a current stock price as a default value, an adjustable equity discount rate relative to the first priceline, an adjustable implied earnings value for the equity discount rate, and a current company earnings value, and
wherein the interactive required earnings projection tool further comprises a current company earnings value, the adjustable implied earnings value, an adjustable growth analysis time period, a desired earnings growth projection curve from the implied earnings value based on an adjustable desired rate of return, a market earnings growth projection curve from the implied earnings value based on the estimated market growth rate, and a required earnings growth projection curve from the current company earnings value to an intersection point on the desired earnings growth projection curve at the end of the selected growth analysis time period.

18. The interactive system of claim 17, wherein the visually intuitive graphical user interface for assessing company valuation and positional risk of a stock price further comprises an interactive historic implied earnings tool, and
wherein the interactive historic implied earnings tool comprises adjustable implied earnings values for historical stock prices based on the adjustable equity discount rate and historical actual earning values as a reference to the adjustable implied earnings values.

19. The interactive system of claim 17, wherein the visually intuitive graphical user interface tool for assessing company valuation and positional risk of a stock price further comprises an interactive historic stock price tool, and
wherein the interactive historic stock price tool comprises values for historical stock prices and historical benchmark interest rates.

20. The interactive system of claim 17, wherein the equity discount rate is a user selectable rate of return value.
